(19) United States
(12) Patent Application Publication
(10) Pub. No.: US 2007/0035105 A1
(43) Pub. Date: Feb. 15, 2007

(54) Suspension stabilizer system with pressure controller device

(76) Inventor: Donald M. Yale, Gladewater, TX (US)

Correspondence Address: Ronald B. Sefrna;Sefrna & Associates, P.O. Box 567, Tyler, TX, 75710-0567, US

(21) Appl. No.: 11/497,883

(22) Filed: Aug. 2, 2006

Related U.S. Application Data
(63) Continuation-in-part of application No. 09/255,277, filed on Feb. 23, 1999, now abandoned.
Application No. 09/255,277 is a continuation-in-part of application No. 08/675,113, filed on Jul. 3, 1996, now Pat. No. 5,873,581.
Application No. 08/675,113 is a continuation-in-part of application No. 08/164,806, filed on Dec. 10, 1993, now abandoned.
Application No. 08/164,806 is a continuation-in-part of application No. 07/930,997, filed on Aug. 17, 1992, now Pat. No. 5,271,638.

(51) Int. Cl. B60G 11/46; B60G 17/00; B60G 11/27

(52) U.S. Cl. 280/124.163; 280/124.157; 280/6.157

(57) ABSTRACT

A pressure controller device having a body with an interior and a plug penetrated by, preferably, a plurality of micro-apertures, disposed in the interior of the body is connected between an air bellows of a vehicle air spring or suspension stabilization system and an air supply line supplying compressed air to the air bellows from an air supply, to temporarily isolate the air bellows from the air supply during the critical milliseconds available for effectively counteracting vehicle and suspension movements, without isolating the air bellows for purposes of adjusting initial pressures and/or load balancing. The pressure controller device of the invention delays air exchange between the air bellows and the air supply system so as to force the air bellows to control itself and provide the immediate response necessary for most effective vehicle stabilization.

### RELATED APPLICATION REFERENCE

This application is a continuation-in-part of U.S. patent application Ser. No. 09/255,277, filed Feb. 23, 1999; which is a continuation-in-part of U.S. patent application Ser. No. 08/675,113, filed Jul. 3, 1996 and issued as U.S. Pat. No. 5,873,581. U.S. patent application Ser. No. 08/675,113 is a continuation-in-part of U.S. patent application Ser. No. 08/164,806, filed Dec. 10, 1993; which is a continuation-in-part of U.S. application Ser. No. 07/930,997, filed Aug. 17, 1992 and issued as U.S. Pat. No. 5,271,638.

### FIELD OF THE INVENTION

The present invention generally relates to pneumatic suspension stabilizers which operate through a connection to the leaf spring of the front steering wheels and the frame of a highway tractor unit, and in its preferred embodiments more specifically relates to damper devices for such suspension stabilizers and to a suspension stabilizer system incorporating damper devices.

### BACKGROUND OF THE INVENTION

Air springs or stabilizers are known in the art and have been disclosed and used in various designs. The following patents are illustrative of various approaches to providing more versatile suspension systems and/or suspension stabilization systems for vehicles used on roadways:

| Pat. No. | Inventor | Issue Date |
|---|---|---|
| 1,470,424 T. | W. E. Brogden | Oct. 9, 1923 |
| 1,714,067 | W. N. Angelus | May 21, 1929 |
| 1,858,783 | A. F. Masury | May 17, 1932 |
| 1,880,703 | T. C. Bischoff et al | Oct. 4, 1932 |
| 1,920,206 | A. F. Masury | Aug. 1, 1933 |
| 1,957,072 | A. F. Masury | May 1, 1934 |
| 2,109,074 | R. W. Wilsson | Feb. 22, 1938 |
| 2,141,781 | LeRoy V. Adler | Dec. 27, 1938 |
| 2,150,622 | N. E. Hendrickson | Mar. 14, 1939 |
| 2,190,311 | M. E. Dayton | Feb. 22, 1938 |
| 2,227,762 | A. Ronning | Jan. 7, 1941 |
| 2,317,057 | T. A. Higby | Apr. 20, 1943 |
| 2,236,734 | A. Ronning | Apr. 1, 1941 |
| 2,566,393 | O. J Wolfe | Sep. 4, 1951 |
| 2,874,956 | D. J. La Belle | Feb. 24, 1959 |
| 2,881,799 | Menewisch | April, 1959 |
| 2,989,300 | P. Johannsen | Jun. 20, 1961 |
| 3,050,316 | Behles | August, 1962 |
| 3,053,548 | J. C. Moore | Sep. 11, 1962 |
| 3,063,732 | Harbers et al | November, 1962 |
| 3,179,439 | R. N Janeway | Apr. 20, 1965 |
| 3,285,281 | Pribonic et al | November, 1966 |
| 3,399,795 | R. V. Clacker et al | Sep. 3, 1968 |
| 3,462,033 | R. J. Rioch | Aug. 19, 1969 |
| 3,489,427 | S. A. Vearnals et al | Jan. 3, 1970 |
| 3,595,408 | Ira C. Eddy | Jul. 27, 1971 |
| 3,703,244 | D. P. Walsh et al | Nov. 21, 1972 |
| 3,722,948 | D. P. Walsh | Mar. 27, 1973 |
| 3,724,695 | R. S. Taylor | Apr. 3, 1973 |
| 3,730,548 | E. B. Thaxton | May 1, 1973 |
| 3,730,550 | E. B. Thaxton | May 1, 1973 |
| 3,866,894 | P. J. Sweet et al | Feb. 18, 1975 |
| 4,033,607 | J. S. Cameron | Jul. 5, 1977 |
| 4,033,608 | P. J. Sweet et al | Jul. 5, 1977 |
| 4,397,478 | J. R. Jensen et al | Aug. 9, 1983 |
| 4,619,467 | J. W. Lafferty | Oct. 28, 1986 |
| 4,789,369 | W. H. Geno et al | Jan. 17, 1989 |
| 4,919,399 | R. J. Selzer et al | Apr. 24, 1990 |

### SUMMARY OF THE INVENTION

The present invention provides an improvement in the ride, handling and steering characteristics of an vehicle equipped with an air spring suspension or an air bellows-type suspension stabilization system. Such systems are often installed on both the tractor unit and trailer unit of large tractor-trailer vehicles, and are also used on other types of transport vehicles, including other types of transport trucks, motor coaches, and recreational vehicles. Air springs are also used for driver and passenger seat suspension within the cabs of such vehicles in an effort to improve driver and rider comfort and reduce fatigue.

Air springs and air bellows suspension stabilizers are used for the general purpose of improving the driving and handling characteristics of the vehicles, which can change as a result of variations in road surface condition, slope, grade, curvature, and texture, and which can also change as a result of changes in the total load and position of the load carried by such vehicles. The problems associated with load variations can be particular prevalent when the cargo carried by a vehicle is subject to frequent changes, as in, for example, a delivery or transport route when some cargo is unloaded and new cargo is loaded at intermediate stops through the route. Weather conditions, especially wind, are also a factor in producing variations in steering and handling characteristics. These factors, acting alone or in combination can create problems with vehicle steering and handling, and produce unsafe driving conditions.

Any conventional spring suspension system is subject to rebound or oscillation after the spring is caused to move from its rest position by relative movement between the axle and frame. When the force causing the spring to initially flex is removed the spring will inherently oscillate around the original rest position before returning to rest, and the vehicle will bounce up and down and/or from side to side during the spring oscillation. Shock absorbers are used to provide a damping effect in an effort to reduce the magnitude and duration of spring oscillation. Typically installed shock absorbers are not adjustable to varying load conditions, however, and are subject to wear that reduces their effectiveness. An air spring suspension system helps alleviate the problems not fully addressed by the conventional shock absorbers, and helps extend the life of the vehicle shock absorbers.

As disclosed in my U.S. Pat. No. 5,873,581, mounting an adjustable air bellows assembly directly above the front leaf spring and directly below the frame on each side of a vehicle such as but not limited to the tractor of a tractor-trailer vehicle augments the original suspension system and stabilizes the vehicle to improve handling and steering characteristics. In such an installation the air bellows is preferably mounted at a point directly above the longitudinal center line of the respective leaf spring between the point of attachment of the axle for the steered wheels and the rear shackle of the leaf spring. Each air bellows assembly is connected to the frame of the tractor directly above the air bellows. The air pressure in the air bellows assemblies can be manually adjusted by the tractor driver so that the air bellows exert the desired force between the tractor frame and the front leaf spring. The force can be adjusted by the driver according to the load distribution between the front wheels and rear wheels of said tractor and the road conditions to achieve optimum driving conditions. Similarly, air bellows assemblies can be mounted on additional axles of the vehicle, including the drive axle(s) and non-driven trailer axles for further stabilization. Air bellows or air springs are also used in what are commonly referred to as load leveling systems. In load leveling systems the air pressure in the bellows is automatically controlled by a system controller and regulator rather than directly by the driver, to level the vehicle and compensate for uneven load distribution.

Although conventional air springs, air stabilizers, and load leveling systems can provide significant improvements in the handling characteristics of the vehicle, some problems remain and further improvements can be achieved. The basic purpose of the air springs or air bellows is to augment the vehicle springs by working with the springs to resist and restrain relative movement between the vehicle axle(s) and frame. Compressed air is supplied to the air bellows from an air source through a pressure regulator and a system of supply lines connected between the pressure regulator and the air bellows. When suspension movement occurs so as to move an axle equipped with an air bellows toward the frame, or the vehicle frame toward the axle, the air bellows is compressed as the associated conventional spring flexes. The intended function of the air bellows is to augment the spring and reduce the movement allowed between frame and axle, reducing sway or pitch of the vehicle. In theory, as the air bellows is compressed the air pressure in the bellows rises, imposing an increasing force to restrain suspension movement. However, in a conventional system, because the air bellows is not isolated from the air supply system, the pressure increase in the bellows does not occur quickly enough for the bellows to most effectively restrain suspension movement. In order for the air bellows to provide the most effective response it is desirable for the air pressure in the bellows to increase immediately when force is applied.

The same problem occurs in a conventional air suspension system when the frame and axle move away from each other so as to extend or expand the air bellows. In order for the air bellows to resist separation of frame and axle to limit suspension movement, the pressure in the air bellows should ideally decrease immediately when movement begins so that the bellows acts to hold or pull the suspension components together. Again, however, because the air bellows is not isolated from the air supply system, in practice the reduction of the air pressure within the bellows itself does not occur immediately, and the most effective immediate response is not achieved. Since it is not practical to completely isolate the air bellows from the air supply system, an effective solution to this problem with air bellows response has not been effectively addressed in the prior art.

The present invention addresses this problem by providing a pressure controller device that acts to temporarily isolate an air bellows from the air supply system during the critical milliseconds available for effectively counteracting vehicle and suspension movements, without isolating the air bellows for purposes of adjusting initial pressures and/or load balancing. The pressure controller device of the invention delays air exchange between the air bellows and the air supply system so as to force the air bellows to control itself and provide the immediate response necessary for most effective vehicle stabilization. In the preferred embodiments of the invention the pressure controller device comprises a cylindrical body with one or more longitudinal orifices having a total cross-sectional area less than the cross-sectional area of the air supply line to the air bellows assembly. A pressure controller device of the invention is preferably installed between each air bellows and the associated air supply line and functions as a gateway between the interior of the air bellows and the air supply line. When the air bellows is subjected to a rapid compression or expansion the pressure controller device restricts pressure equalization between the air bellows and the air supply line, effectively isolating the air bellows during the critical initial response time so that the air bellows responds to compression with an immediate pressure increase and responds to expansion with an immediate pressure decrease. As a result, the air bellows reacts so as to exactly match and counteract the actions of the vehicle suspension and the movement of the vehicle on the suspension.

The structure and features of the pressure controller device of the invention, in the context of associated air bellows stabilizers, will be described in detail with reference to the accompanying drawing figures.

### BRIEF DESCRIPTION OF THE DRAWINGS

FIG. 1 is a side view of a typical vehicle frame member and leaf spring suspension with an air bellows unit of an air spring system installed between the frame member and the leaf spring.

FIG. 2 is a front elevation view of a vehicle axle and leaf spring suspension with air bellows units installed between the leaf springs and vehicle frame members.

FIG. 3 is a front elevation view of an air bellows assembly for an air spring or suspension stabilization system.

FIG. 4 is a schematic illustration of an air bellows with a pressure controller device of the invention installed between the air bellows and the air supply line.

FIG. 5 is a schematic illustration of an air bellows unit with two air bellows, with a pressure controller device of the invention installed on each air bellows.

FIG. 6 is a schematic illustration of an air bellows unit with three air bellows, with a pressure controller device of the invention installed on each air bellows.

FIG. 7 is a side elevation view of a first embodiment of a pressure controller device of the invention.

FIG. 8 is a sectioned side elevation view of the first embodiment of a pressure controller device of the invention, with a multiplicity of aligned apertures.

FIG. 9 is a sectioned end view of the first embodiment of a pressure controller device of the invention, having a multiplicity of apertures.

FIG. 10 is a sectioned side elevation view of a second embodiment of a pressure controller device of the invention, having a single aperture.

FIG. 11 is a sectioned side elevation view of an alternative embodiment of a pressure controller device of the invention, having a porous plug.

### DETAILED DESCRIPTION OF THE INVENTION

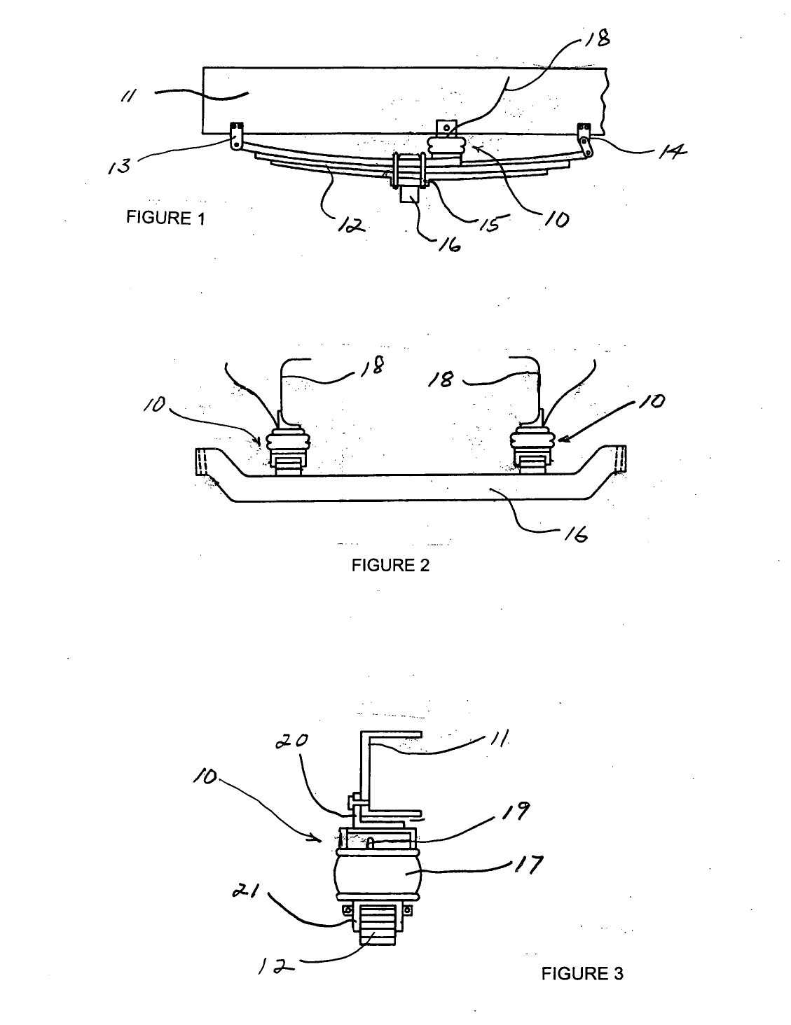

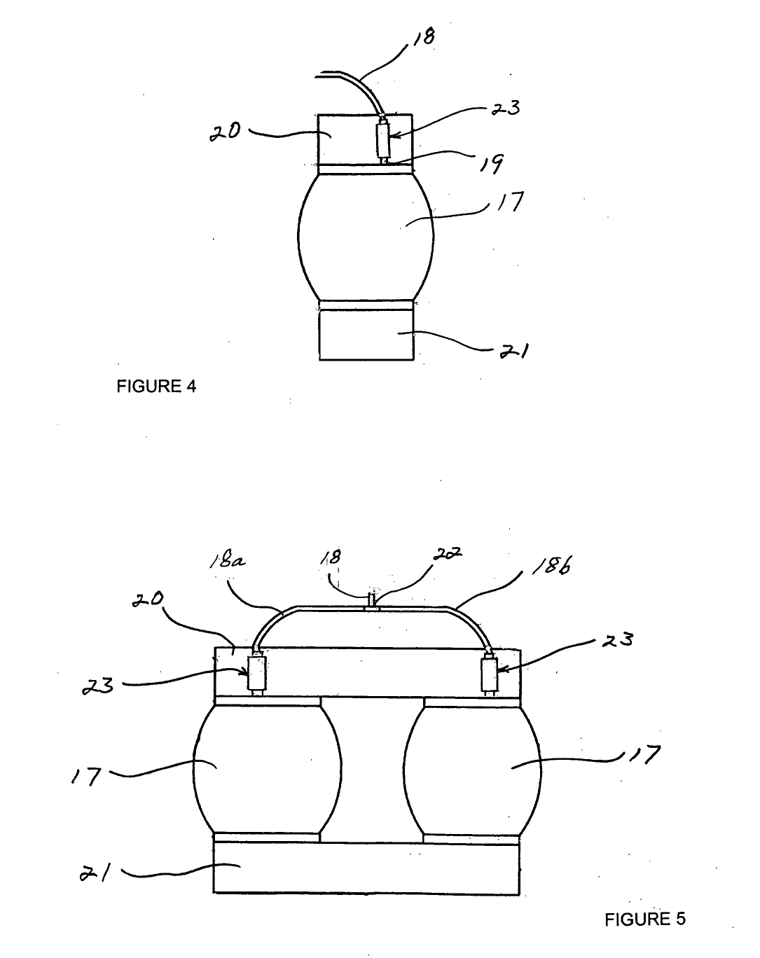

The pressure controller device of the invention is intended to be installed and used in an air spring system, suspension stabilization system, and/or load leveling system. A preferred use of the pressure controller device is with an air bellows suspension stabilizer system as described and claimed in my U.S. Pat. No. 5,271,638, and my U.S. Pat. No. 5,873,581, which are incorporated herein by reference. In such systems, as illustrated in FIGS. 1 and 2, an air bellows assembly, generally identified by reference number 10, is mounted between a vehicle frame member 11 and a leaf spring 12, which is secured to frame member 11 by front spring shackle 13 and rear spring shackle 14. The preferred placement of the air bellows assembly is between the axle mounting 15 for the axle 16 and the rear spring shackle.

As illustrated in more detail in FIG. 3, air bellows assembly 10 includes a hollow bellows 17, formed of an elastomeric material. An air supply line 18 provides an air flow passageway from a source of compressed air (not shown) and pressure regulator (not shown) to the interior of bellows 17. Air supply line 18 is connected to bellows 17 through an aperture or fitting 19. A frame mounting bracket 20 is connected to the upper end of bellows 17, for connection of the bellows to the vehicle frame member, and a spring mounting saddle 21 is connected to the lower end of bellows 17. It is to be understood that air bellows assemblies 10 are installed in matching pairs, or in matching multiples, on each side of the vehicle, so that the installation is laterally symmetrical across the longitudinal center line of the vehicle.

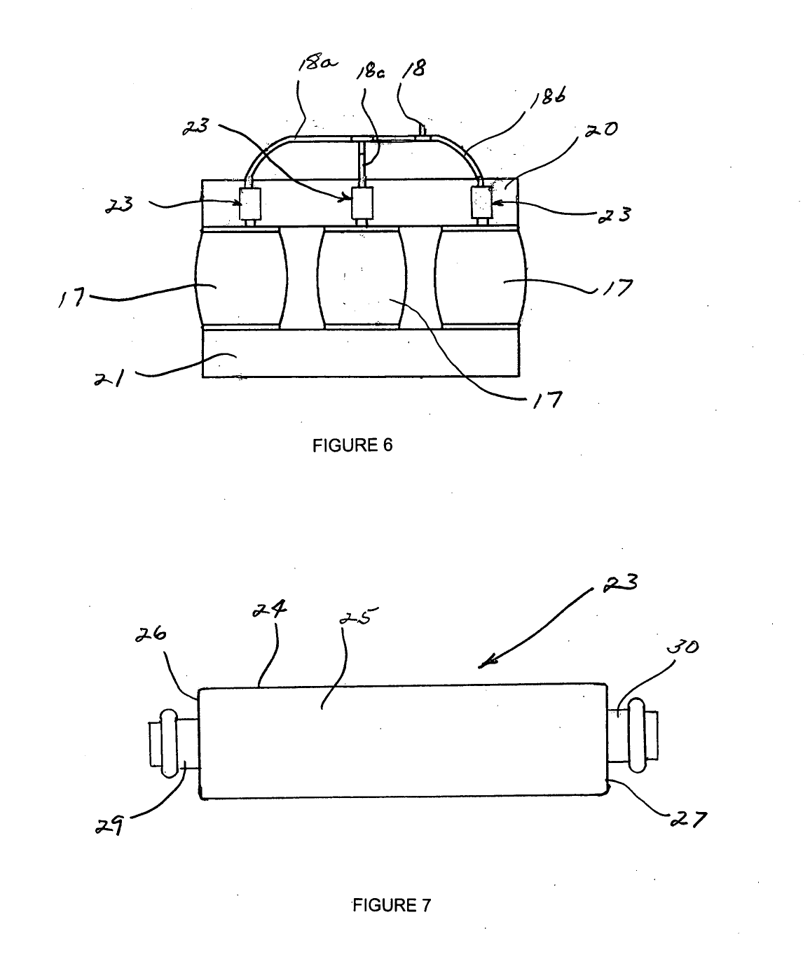

Air bellows assemblies may include a single air bellows or may include multiple bellows. An air bellows assembly with two air bellows is illustrated in FIG. 5 and an assembly with three air bellows is illustrated in FIG. 6. In the two bellows assembly of FIG. 5, air supply line 18 from the air source is split at a T-fitting 22, with an air supply line 18a extending from the fitting to one bellows 17 and an air supply line 18b extending to the second bellows. In the three bellows assembly of FIG. 6, air supply lines 18a, 18b, and 18c extend to the different air bellows from the fitting 22.

As a vehicle equipped with air bellows assemblies such as those described above travels over the road, variations in the road surface and grade, such as bumps and dips or potholes, produce relative movement between the axles and wheels and the frame, causing the springs to flex and the air bellows to engage, compressing and expanding. Spring flex and air bellows engagement also occurs in response to braking and acceleration of the vehicle. With an air spring or air bellows suspension stabilizer system the vehicle operator is able to adjust the initial air pressure in the bellows, and in a load leveling system the initial air pressure in the bellows is adjusted by the system controller. During operation of the vehicle over the road neither the air bellows remain connected to the air supply lines with no isolation of the bellows and of the air within the bellows from the remainder of the system.

During operation of the vehicle over the road, when movement between the vehicle frame (and attached body) and the suspended axle(s) causes an air bellows to compress, the internal volume of the bellows is reduced. If the air bellows were isolated, the air pressure within the bellows would immediately increase in direct response to the compression. However, in a conventional installation, without the pressure controller device of the invention, the bellows is not isolated, and the compression of the bellows initially causes a movement of air from the bellows into the air supply line rather than an immediate increase in air pressure within the bellows. Air pressure within the bellows will increase with continuing compression, but only after an initial delay. Because the internal pressure of the air bellows does not immediately increase when suspension movement begins to compress the air bellows, there is a lag in the stabilizing response provided by the air bellows. The delayed response of the air bellows not only allows more initial suspension movement than is desirable, but can also contribute to an undesirable suspension rebound in the opposite direction. Conversely, when the relative movement between vehicle frame and suspended axle(s) causes an air bellows to expanded, the internal volume of the air bellows increases, tending to decrease the air pressure within the air bellows. If the air bellows were isolated, the immediate decrease in air pressure within the bellows would act to restrain expansion of the air bellows and the air bellows would provide an immediate force to counteract the movement of the vehicle suspension. However, because the air bellows in a conventional system, without the pressure controller device of the invention, is not isolated from the air supply system, there is a delay in the pressure decrease within the bellows and a corresponding delay in the response of the air bellows to suspension movement.

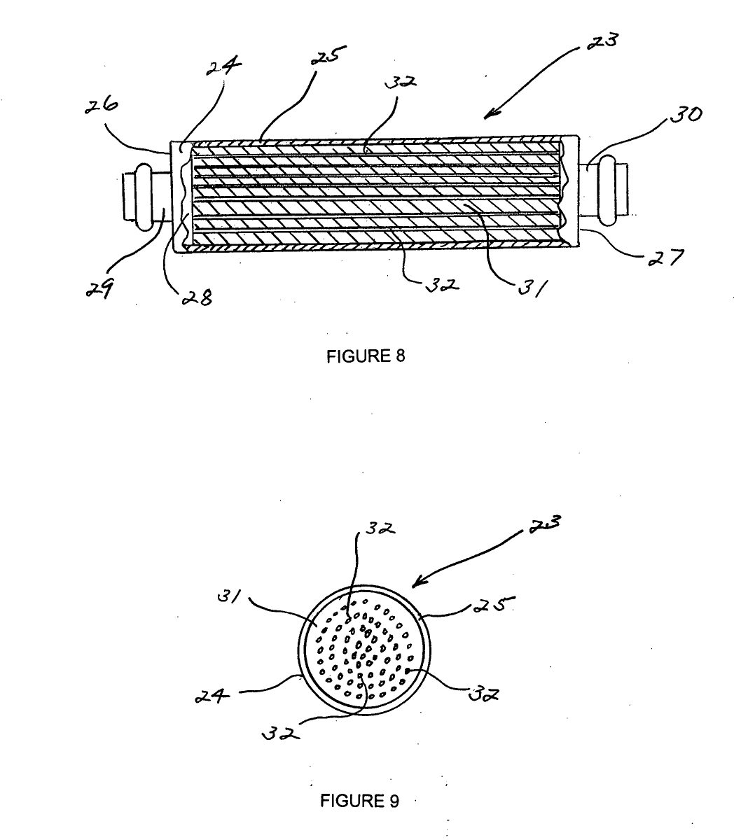

The pressure controller device of the invention, illustrated in several embodiments in FIGS. 7 through 11, provides a means for creating a temporary isolation of an air bellows at the initiation of compression or expansion of the air bellows, eliminating the delay in pressure change within the air bellows that otherwise occurs, and allowing the air bellows to provide the immediate response to movement required for effective stabilization. Although the pressure controller device acts to isolate an air bellows during conditions of rapid pressure change within the air bellows, it has no effect during gradual pressure changes and does not impede or interfere with air pressure adjustments by a vehicle operator or by the system controller.

In the preferred embodiment, the pressure controller device of the invention, illustrated in FIGS. 7, 8, and 9, and generally designated by reference number 23, comprises a body 24 with a side wall 25, a first end 26, and a second end 27, surrounding an interior 28. A first connection fitting 29 is disposed at first end 26 to provide an air passageway through the connection fitting to the interior of the body at the first end, and a second connection fitting 30 is disposed at second end 27 to provide an air passageway through the connection fitting to the interior of the body at the second end. At least one of fittings 29 and 30 is connected to an air supply line 18 providing a supply of compressed air to an air bellows 17 through the pressure controller device. It is preferred that body 24 be of cylindrical configuration, although it is to be understood that the specific configuration of the body is not critical to the scope of the invention, and other configurations may be used if desired. The internal structure of the pressure controller device of the invention, and the effect on pressure changes within an air spring or suspension stabilization system produced by the internal structure of the device is much more significant than the configuration of the outer body itself.

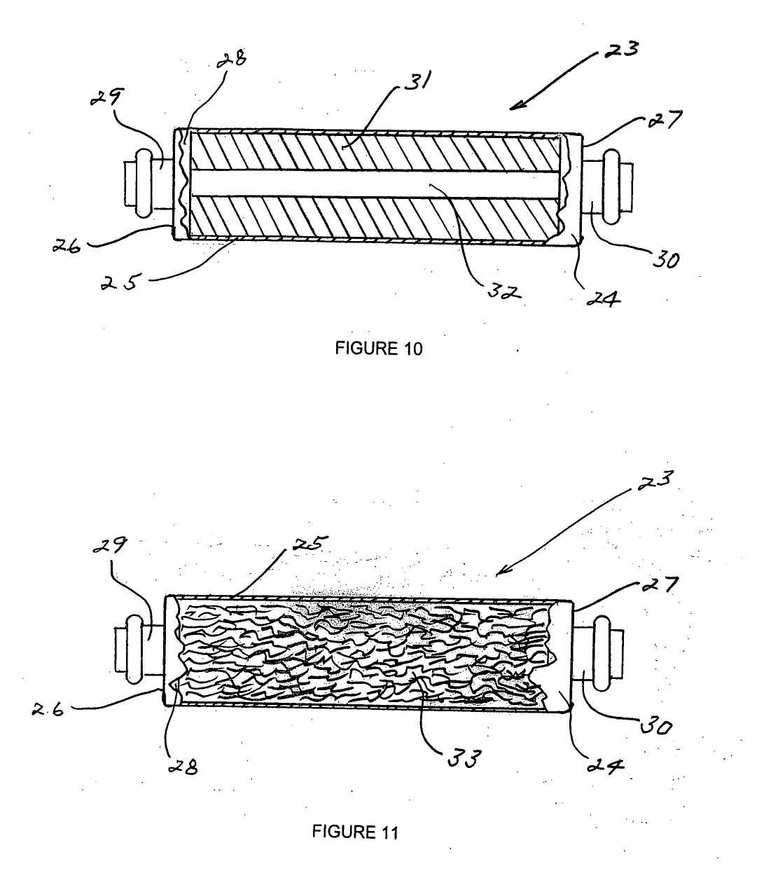

In a preferred first embodiment of the pressure controller device of the invention the interior of body 24 is generally open at each end adjacent to fittings 29 and 30, but closed through its central portion by plug 31. In this embodiment plug 31 is penetrated by a plurality of micro-apertures or orifices 32 that extend linearly through plug 31 in generally parallel relation to each other and to the longitudinal axis of the plug. The combined cross-sectional area of orifices 32 is less than the cross-sectional area of air supply line 18. It will be understood that the ratio between the combined cross-sectional area of orifices 32 and the cross-sectional area of air supply line 18 can be adjusted by variations in the cross-sectional area of each individual orifice 32 and/or the number of such orifices formed through plug 31. It will be further understood that the minimum number of orifices 32 extending through plug 31 in this embodiment of the device is one, as shown in FIG. 10. When air is moved at low velocity through the body of the device, and thus through orifices 32, the pressure differential across plug 31 is low, and the device of the invention provides essentially no resistance to air flow or to pressure equalization across the device.

In an alternative approach to the use of a solid plug 31 penetrated by discrete orifices 32, a porous plug 33 may be disposed in the interior of body 24, as illustrated in FIG. 11. Plug 33 is formed of a porous material, such as a sintered metal or a porous ceramic material, so as to establish a multiplicity of non-linear flow paths through plug 33. As with the embodiment described above, the total cross-sectional area available for air flow through plug 33 is less than the cross-sectional area of air supply line 18. The flow of air through a porous plug is influenced not only by the ratio of cross-sectional areas, but also by the degree of non-linearity of the flow paths through the material of construction of the porous plug. The characteristics of flow control can be controlled through selection of the porosity of the plug. As with the embodiment utilizing discrete orifices through a solid plug 31, at low air flow rates and low air velocity, plug 33 imposes little restriction on air flow and pressure differential across the plug is low.

With either embodiment, however, when the air pressure on one side of the pressure controller device is changed rapidly relative to the air pressure on the other side of the device, either increased or decreased, the structure of the device creates a resistance to pressure equalization across the device, and the pressure differential across the device is initially maintained. The function of the pressure controller device in maintaining a rapidly imposed pressure differential is significant in improving the response of the air bellows in an air spring or suspension stabilization system. Because different suspension systems react differently to road conditions, the ability to vary the characteristics of the pressure controller device allows an air bellows suspension stabilization system to be tuned to the characteristics of the vehicle on which it is installed. The pressure controller device of the invention allows a previously unattainable level of control and improvement in vehicle stability, handling, and safety.

The pressure controller device is preferably installed in conjunction with the air bellows in such systems with a pressure controller device disposed between each air bellows 17 and the air supply line 18 to each such air bellows. Accordingly, it is preferred that first connection fitting 29 be adapted to connect directly to the air bellows air supply line fitting 19, and that the second connection fitting 30 of the pressure controller device be adapted to connect to the air supply line 18. A particularly preferred connection type is a quick-connect, push-lock fitting, to facilitate connection and disconnection of the pressure controller devices and air supply lines, but it will be understood that any other type of fitting design suitable for making and maintaining a secure connection may be used, including but not limited to threaded pipe fittings or clamp connections. Although it is preferred that the pressure controller device be connected directly to the air bellows, the pressure controller device may be separated a short distance from the air bellows and installed “in-line” in the air supply line if necessary. However, the distance of separation from the air bellows should be minimized for most effective operation of the pressure controller device.

Each air bellows controlled by a pressure controller device of the invention is in air flow communication with the air supply system through the pressure controller device, and initial adjustment of air pressure in the controlled air bellows with the vehicle at rest is not affected by the device. During suspension adjustments the pressure changes are accomplished relatively slowly, pressure differentials across the device are low, and any movement of the vehicle on the suspension occurs slowly and gradually.

When the vehicle is in motion on a road surface, however, relative movements between the vehicle frame and the suspended axle(s) occur very rapidly, resulting in rapid compressions and expansions of the air bellows, and rapid creation of high pressure differentials across the pressure controller device(s) on the affected air bellows. In this circumstance the pressure controller device immediately functions to maintain the pressure differential and prevent rapid equalization, effectively isolating the controlled air bellows. With the air bellows isolated from the air supply system, delay in pressure change within the air bellows in response to compression or expansion is eliminated, and the air bellows functions to immediately counteract the motion causing the compression or expansion. The immediate response provided by air bellows equipped with the pressure controller device of the invention damps suspension movement, maintaining vehicle stability and safety much more effectively than air bellows without such control. The delay in response by an uncontrolled air bellows can actually degrade vehicle stability and safety by increasing, rather than damping, suspension rebound effects.

Although each controlled bellows is effectively isolated by the attached pressure controller device, the effect of immediate air bellows response on the stability of the vehicle is interactive. For example, when the wheels on each end of an axle equipped with air bellows encounter a bump simultaneously, moving the axle toward the vehicle frame and compressing the air bellows on each side of the vehicle, the immediate increase in air pressure within the controlled bellows restrains upward movement of the axle. When the wheels pass over the bump and move downward away from the frame, the immediate decrease in air pressure within the controlled air bellows acts to pull the frame and suspension together, minimizing suspension bounce and the tendency of the vehicle to pitch. As another example, when road or wind conditions cause a vehicle to roll, controlled air bellows on each side of the vehicle function to damp the rolling movement and prevent rebound. The increased air pressure in the controlled air bellows in compression on one side of the vehicle causes the air bellows to push upward on the vehicle frame, while the decreased air pressure in the controlled bellows in expansion on the opposite side of the vehicle causes those air bellows to pull downward on the vehicle frame. Any tendency of the vehicle to roll on the suspension in the opposite direction after recovery is immediately damped.

In addition to improving the response of air bellows in vehicle suspension systems, the pressure controller device of the invention also improves the response and effectiveness of air spring systems for other purposes, such as vehicle seats. It is relatively common for truck seats to be equipped with spring systems using air bellows. Installation of a pressure controller device on the air bellows improves the response of the seat suspension to movement, prevents the seat from “bottoming out”, and generally improves seat comfort and function for the user.

The foregoing description of preferred and alternative embodiments of the invention is intended to be illustrative rather than limiting of the full scope of the invention. Additional embodiments and variations in, e.g., the pressure controller device of the invention may be devised by those of skill in the art on the basis of the disclosure and teachings herein.

1. A pressure controller device for a vehicle suspension stabilizer system having an air bellows, a source of compressed air, and an air supply line connected between the source of compressed air and the air bellows to establish a passageway for compressed air between the source of compressed air and the air bellows, comprising
a body having an interior and having first and second ends, said body connected in air flow communication through said interior of said body between the source of compressed air and the air bellows; and
a plug having a first end and a second end, said plug disposed in said interior of said body between said first end of said body and said second end of said body with said first end of said plug adjacent to said first end of said body and with said second end of said plug adjacent to said second end of said body, said plug being penetrated by at least one aperture extending between said first end of said plug and said second end of said plug to create an air flow passageway through said plug, the cross-sectional area of said at least one aperture being substantially less than the cross-sectional area of the air supply line.

2. The pressure controller device of claim 1, wherein said body further includes a first connection fitting at said first end of said body for connecting said first end of said body directly to the air bellows, and a second connection fitting at said second end of said body for connecting said second end of said body to the air supply line.

3. The pressure controller device of claim 1, wherein said body includes a first connection fitting at said first end of said body and a second connection fitting at said second end of said body, for connecting said body in the air supply line to the air bellows.

4. The pressure controller device of claim 1, wherein said at least one aperture comprises a plurality of generally parallel apertures and wherein the total cross-sectional area of said plurality of apertures is substantially less than the cross-sectional area of the air supply line.

5. The pressure controller device of claim 1, wherein said plug is formed of a porous material and wherein said at least one aperture comprises a multiplicity of non-parallel interconnected passages through said plug.

6. The pressure controller device of claim 2, wherein said first connection fitting and said second connection fitting are quick-lock fittings.

7. The pressure controller device of claim 2, wherein said first connection fitting comprises a threaded nipple and wherein said second connection fitting is a quick-connect fitting.

8. In a suspension stabilization system for a vehicle having an axle moveably mounted to vehicle frame members by flexible leaf springs, the suspension stabilization system including air bellows, each with a hollow interior and a volume of air contained therein, disposed and connected between the leaf springs and the associated frame members such that the air bellows are caused to expand and compress by movement of the axle relative to the frame members, a source of compressed air, and air supply lines connected between the source of compressed air and each air bellows to establish a passageway for compressed air therebetween, the improvement comprising
a pressure controller means connected between each of said air bellows and said air supply line to said air bellows such that the passageway for compressed air to said bellows is through said pressure controller means, for the purpose of temporarily isolating each of said air bellows from said air supply line to said bellows immediately upon and for a period of time during each expansion and during each compression of said air bellows caused by relative movement of the axle of the vehicle relative to the frame members of the vehicle, so as to cause the pressure of the volume of air contained in the interior of each of said bellows to change in direct response to the expansion or contraction of said bellows independently of the air pressure in said air supply line to said bellows during said period of time.

9. The improvement of claim 8, wherein said pressure controller means comprises
a body having an interior and first and second ends, a first connection fitting at said first end and a second connection fitting at said second end for connecting said body between said air bellows and said air supply line;
a plug having a first end and a second end, disposed in said interior of said body between said first and second ends of said body, said plug penetrated by a multiplicity of micro-apertures extending between said first end of said plug and said second end of said plug, the combined cross-sectional area of said micro-apertures being substantially less than the cross-sectional area of said air supply line.

10. The improvement of claim 8, wherein said pressure controller means comprises
a body having an interior and first and second ends, a first connection fitting at said first end and a second connection fitting at said second end for connecting said body between said air bellows and said air supply line;
a plug having a first end and a second end, disposed in said interior of said body between said first and second ends of said body, said plug penetrated by an aperture extending between said first end of said plug and said second end of said plug, the cross-sectional area of said aperture being substantially less than the cross-sectional area of said air supply line.

11. The improvement of claim 8, wherein said pressure controller means comprises
a body having an interior and first and second ends, a first connection fitting at said first end and a second connection fitting at said second end for connecting said body between said air bellows and said air supply line;
a plug having a first end and a second end, disposed in said interior of said body between said first and second ends of said body, said plug formed of a porous material establishing a multiplicity of passageways for the flow of air through said plug.

12. An air spring system for damping movement between a first member and a second member which are disposed in close proximity to each other and are moveable toward each other and away from each other in response to outside force, comprising
an air bellows having a flexible body with a hollow interior containing a volume of air in said interior, and a fitting in said body forming an air flow passageway from said interior of said body to the exterior of said body, said air bellows connected between said first and second members such that said air bellows is expanded when said first and second members are moved apart and compressed when said first and second members are moved together;
a source of compressed air for supplying air to said air bellows;
an air supply line having a first end and a second end and a hollow interior, said air supply line connected at said first end to said source of compressed air forming a passageway for the flow of air between said source of compressed air and said air bellows; and
a pressure controller means having a first end and a second end and an interior, said pressure controller means connected at said first end to said fitting of said air bellows and connected at said second end to said second end of said air supply line, forming an air flow passageway through said interior of said pressure controller means between said interior of said air bellows and said air supply line, said pressure controller means temporarily isolating said interior of said air bellows from said air supply line during rapid expansion of said air bellows when said first and second members rapidly move apart, and during rapid compression of said air bellows when said first and second members rapidly move together, such that the air pressure in said interior of said air bellows decreases independently of the air pressure in said air supply line during said rapid expansion of said air bellows, and such that the air pressure in said interior of said air bellows increases independently of the air pressure in said air supply line during said rapid compression of said air bellows.

13. The air spring system of claim 12, wherein said pressure controller means includes a plug having a first end and a second end, disposed in said interior, said plug penetrated by a multiplicity of micro-apertures extending between said first end of said plug and said second end of said plug, the combined cross-sectional area of said micro-apertures being substantially less than the cross-sectional area of said air supply line.

14. The air spring system of claim 12, wherein said pressure controller means includes a plug having a first end and a second end, disposed in said interior, said plug penetrated by an aperture extending between said first end of said plug and said second end of said plug, the cross-sectional area of said aperture being substantially less than the cross-sectional area of said air supply line.

15. The air spring system of claim 12, wherein said pressure controller means includes a plug disposed in said interior, said plug formed of a porous material establishing a multiplicity of passageways for the flow of air through said plug.

16. The air spring system of claim 12, wherein said first member is a vehicle frame member and said second member is a leaf spring connected to said frame member.

17. The air spring system of claim 12, wherein said first member is a vehicle frame member and said second member is a vehicle axle flexibly suspended relative to said frame member.

19. The air spring system of claim 12, wherein said first member is a frame member of a vehicle seat and wherein said second member is a floor plate underlying said frame member.
